(19) United States
(12) Patent Application Publication
(10) Pub. No.: US 2017/0358020 A1
(43) Pub. Date: Dec. 14, 2017

(54) INFORMED FOOD SELECTION IN A PARTICULAR EATING ENVIRONMENT

(71) Applicant: International Business Machines Corporation, Armonk, NY (US)

(72) Inventors: Michael Bender, Rye Brook, NY (US); Rhonda L. Childress, Austin, TX (US); David B. Kumhyr, Austin, TX (US); Michael J. Spisak, East Northport, NY (US)

(21) Appl. No.: 15/182,257

(22) Filed: Jun. 14, 2016

(51) Int. Cl. G06Q 30/06; G06F 19/00; G06Q 50/12

(52) U.S. Cl. CPC G06Q 30/0621; G06Q 50/12; G06Q 30/0641; G06F 19/3475

(57) ABSTRACT

A first unit of data associated with one or more sensor devices may be received. The first unit of data may identify food information about one or more food items. A compliance estimate may be generated, by comparing the food information against a set of food intake criteria tailored to the user, to determine whether the food information complies with the set of food intake criteria. A notification may be provided to the user based on whether the food information complies with the set of food intake criteria.

### BACKGROUND

This disclosure relates generally to food selection technologies, and more specifically, to providing suitable food choices to a user that are tailored to the user's preferences and/or dietary restrictions.

There are various food tracking technologies and mobile device applications that provide nutritional information to users. For example, a SMARTPLATE (by FITLEY, Inc.) is a food plate computing device that includes three object recognition cameras and a load sensor. When a user places a portion of food on the SMARTPLATE, the load sensor calculates a weight of the portion, which allows an inference to be made concerning the serving size. Further, the object recognition cameras identify the food that is on the plate through various complex algorithms that rely on matching, learning, and/or pattern recognition techniques. These data obtained from the sensors are then transmitted from the SMARTPLATE to an associated server or mobile application such that the user knows what and how much he/she is consuming. Other technologies include calorie counting and/or meal tracking applications. For example, a user may manually log in and record every item that the user eats and/or drinks each day, as well as the portion sizes. These entries may then be compared to a central food database in order to determine the dietary content of the food eaten, such as calories, fat intake, carb intake, etc.

### SUMMARY

Various embodiments are directed to a method, a system and a computer program product for selecting suitable food choices tailored to user preferences. A first unit of data associated with one or more sensor devices may be received. The first unit of data may identify food information about one or more food items. A compliance estimate may be generated, by comparing the food information against a set of food intake criteria tailored to the user, to determine whether the food information complies with the set of food intake criteria. A notification may be provided to the user based on whether the food information complies with the set of food intake criteria.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a computing environment, according to embodiments.

FIG. 2 is a diagram of a buffet environment illustrating how food information may be obtained, according to embodiments.

FIG. 3 is a diagram illustrating how food information may be obtained, according to embodiments.

FIG. 4 is a flow diagram of a process for determining whether received food information complies with a set of food intake criteria and recommending to add and/or remove food items responsively, according to embodiments.

FIG. 5 is a block diagram of a computing device that includes a food compliancy module, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to food selection technologies, more particular aspects relate to providing suitable food choices to a user that are tailored to the user's preferences. While the present disclosure is not necessarily limited to such applications, various aspects of the disclosure may be appreciated through a discussion of various examples using this context.

A person may poorly select food and/or control nutritional quantities of food (e.g., calorie intake, trans fats intake, etc.) according to his/her food intake needs and/or preferences. This may be the case particularly in places such as restaurants where nutritional information may be inaccessible or hard to obtain. For example, a person that is gluten intolerant may try to eat out at a restaurant. However, the restaurant food nutritional data may be unattainable, thereby making the person guess which foods do not have gluten. The person may decide not to eat at the restaurant altogether because of this uncertainty.

Embodiments of the present disclosure improve or replace the food tracking computing devices/technologies discussed above. For example, the SMARTPLATE, calorie counting and/or meal tracking applications may not be able function properly in a restaurant and/or buffet environment because of limited nutritional data. Further, these applications may require a substantial quantity of time to manually enter and track each consumed food item and serving sizes for each day, thereby making these operations too arduous for users. Moreover, these applications and the SMARTPLATE may only calculate or transmit static data based on what a user will consume (e.g., calories, portion size). Embodiments of the present disclosure may allow users to obtain nutritional information in a restaurant and/or buffet environment. This may occur via one or more automated or background tasks such that the user does not have to manually input data (or the user may input minimal data) on a computing device, which therefore may improve the computer functionality of these technologies. Further, in some embodiments, these technologies and/or computer functionality may be improved by dynamically generating a compliance estimate in order to determine what a user should eat in a particular environment (e.g., a buffet) based on the user's food intake criteria, as opposed to only statically calculating a quantity of calories (or other nutritional information) a food item contains.

As disclosed herein, the term “food intake criteria” may refer to a special set of one or more rules/policies associated with particular food, food combination, food ingredient (e.g., high fructose corn syrup), and/or other food element (e.g., chemical compounds, molecules, minerals, vitamins, calories, etc.) that a particular user should or should not intake or eat. The food intake criteria may be tailored or personalized to the particular user. In various embodiments, the food intake criteria may be selected based on food the user prefers to eat—or not eat—and/or personalized dietary restrictions. For example, dietary restrictions may be associated with a personal profile of particular food limitations that the user is aiming to adhere to (e.g., a particular quantity of calories to be consumed in a given day). Food intake criteria may be based on one or more factors such as a food ingredient intolerance of the user (e.g., lactose or glucose intolerant), a food allergy of the user, a special diet regime of the user, a calorie consumption target or goal of the user, a health-related factor (e.g., diabetes) associated with the user, and/or religious dietary restrictions, etc. A “special diet regime” may refer to when a user eats (or does not eat) a particular food, food combination, and/or food ingredient item, which may occur for a special purpose (e.g., a vegetarian diet, a low/no-carb diet, a low-fat diet, no-bread diet, etc.). A “health-related factor” may refer to avoiding or implementing particular foods, food combinations, food ingredients, and/or food elements based on one or more health reasons. For example, a person may need a particular quantity of simple carbohydrates in order to counteract low blood glucose levels associated with hypoglycemia.

Embodiments of the present disclosure may allow for a transformation of an original meal selection into a different meal selection for a particular user. For example, the user may have initially placed a 16 oz. steak and 400 calorie brownie on his/her plate. However, sensors may detect that the user has gone over a calorie threshold according to his/her food intake criteria. Accordingly, embodiments for example, may recommend replacing the brownie with a bowl of green gelatin dessert (which the user may also like but does not know it exists in the restaurant). The green gelatin dessert may cause the calorie count to fall under the calorie threshold according to the food intake criteria. Therefore, the user's meal selection has been transformed from a steak with a brownie into a steak with green gelatin dessert.

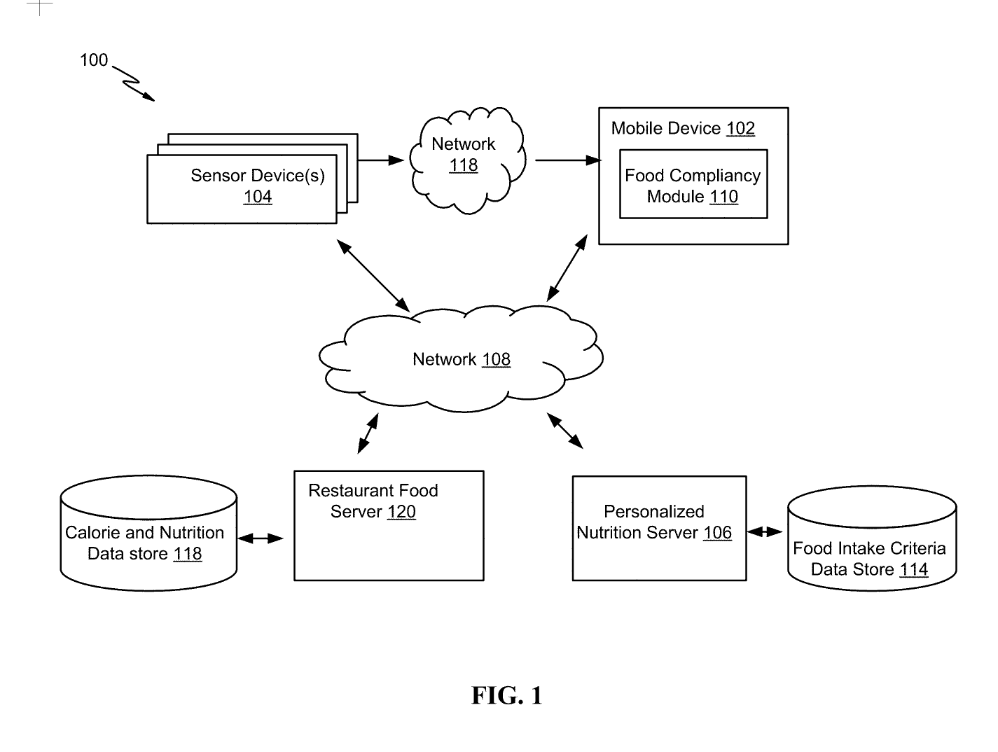

FIG. 1 is a block diagram of a computing environment 100, according to embodiments. The computing environment 100 may include one or more sensor devices 104. In some embodiments, each of the sensor devices 104 are each communicatively coupled with each other (e.g., via the network 118) and to the mobile device 102, the restaurant food server 120 and/or the personalized nutrition server 106 (e.g., via the network 108 and/or 118). In some embodiments, the computing environment 100 may be implemented within a cloud computing environment, or use one or more cloud computing services. Consistent with various embodiments, a cloud computing environment may include a network-based, distributed/data processing system that provides one or more cloud computing services. Further, a cloud computing environment may include many computers, hundreds or thousands of them or more, disposed within one or more data centers and configured to share resources over the network 108.

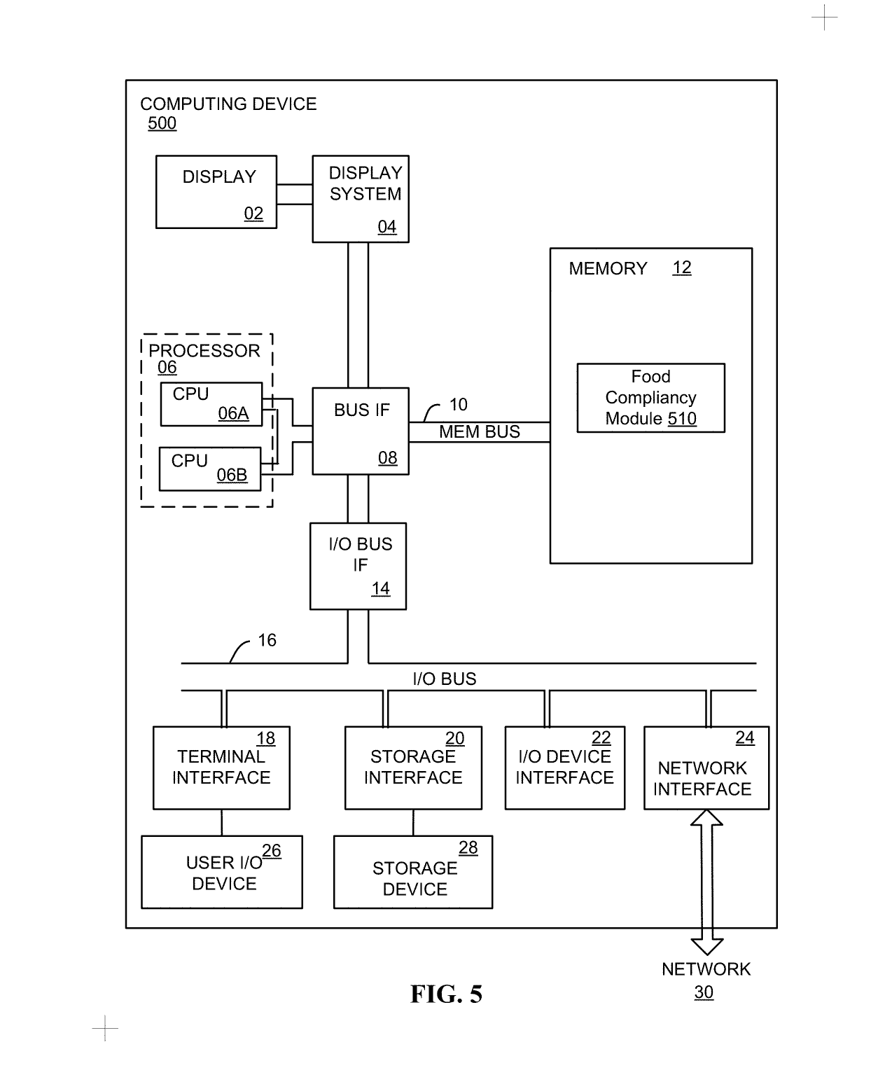

Consistent with some embodiments, the sensor devices 104, the mobile device 102, the restaurant food server 120, and/or the personalized nutrition server 106 may be configured the same as or analogous to the computing device 500 as illustrated in FIG. 5. In some computing environments, more or fewer components may be present than illustrated in FIG. 1. In various embodiments, some or each of the components—e.g., the restaurant food server 120 and the personalized nutrition server 106—represent separate computing devices. In some embodiments, some or each of the components represent particular compute instances of a single computing device (e.g., program modules, computing components within a chassis, a blade server within a blade enclosure, an I/O drawer, a processor chip, etc.)

In some embodiments, the mobile device 102 is a particular machine that includes a food compliancy module 110. In some embodiments, the food compliancy module 110 represents program instructions and when coupled with a processor is configured to receive data from the sensor device(s) 104. The sensor device(s) 104 may identify food information about one or more food items and transmit this data to the food compliancy module 110 (e.g., via the network 118). “Food information” may refer to one or more food attributes that describe food in a particular way. For example, food information may include one or more of: an identity of an item of food, nutritional information about the food (e.g., caloric content, fat content, sodium levels, etc.), the serving size that a person has placed on his/her plate (or other dish), whether the food includes any forbidden ingredients (e.g., ingredient(s) that a particular user avoids consuming because of allergies, preferences, and/or dietary restrictions, etc.). The food compliancy module 110 may also be configured to generate, by comparing the food information against a set of food intake criteria tailored to the user, a compliance estimate to determine whether the food information complies with the set of food intake criteria. Further, the food compliancy module 110 may be configured to provide a notification to a user based on whether the food information complies with the set of food intake criteria.

The sensor device(s) 104 may communicate with the mobile device 102 via the network 118, which may be any suitable network such as a Personal Area Network (PAN) (e.g., a Bluetooth® (by BLUETOOTH SIG) network), a local area network (LAN), a general wide area network (WAN), and/or a public network (e.g., the internet). In some embodiments, the sensor device(s) 104 communicate with the mobile device 102 in order to transmit a unit of data that includes food information about one or more food items, as described in more detail below. The sensor device(s) 104 and/or the mobile device 102 may also communicate with the other components (e.g., the restaurant food server 120 and the personalized nutrition server 106) via any suitable network 108. For example, the network 108 may be a LAN, a WAN, and/or a public network.

The sensor device(s) 104 may be devices that include one or more sensors that determine one or more attributes (food information) for a particular food item that placed on, in, and/or next to the sensor device(s) 104. For example, the sensor device(s) 104 can be or include: SMARTPLATEs (or other plates), buffet trays, buffet tables, cups, bowls, utensils, platters, refrigerators, any portion of a restaurant building, home, etc. In various embodiments, the sensors may be or include: beacons that include Bluetooth® Low Energy (BLE) tags/readers, Radio-frequency Identification (RFID) tags/readers, Near Field Communication (NFC) tags/readers, accelerometers, gyroscopes, microphones, temperature sensors, object recognition cameras, load or weight sensors, sonar sensors, range finder sensors, tactile sensors (e.g., whiskers, bump sensors, touch sensitive skin, etc.), stereo vision sensors, etc. The function of the sensors are described in more detail below.

The restaurant food server 120 may be a particular machine server computing device associated with a particular environment (e.g., a restaurant, a home, etc.) that stores calorie and/or other nutrition data of all of the environment's food to the calorie and nutrition data store 118. For example, a restaurant may have 100 recipes with over 800 food items. The calorie and nutrition data store 118 may store all of the dietary information about each of the 800 food items within the restaurant such as: all of the food ingredients and/or chemical compositions (e.g., compounds, molecules, etc.) for each food item, calories per serving for each food item, fat content per serving for each food item, vitamin content per serving for each food item, mineral content per serving for each food item, sodium, cholesterol, carbohydrates, etc. In another example, the restaurant food server 120 may include dietary information about each food item that is within a particular refrigerator and/or freezer of a particular home.

The restaurant food server 120 may be configured to transmit the food information contained in the calorie and nutrition data store 118 to the food compliancy module 110 and/or one or more of the sensor device(s) 104 (e.g., via the network 108). For example, a restaurant may include one or more beacons with BLE tags that are configured to broadcast packets of data to mobile devices at particular intervals. A reader located within the mobile device 102 may interrogate one or more of the BLE tags and consequently data from the calorie and nutrition data store 118 may be transmitted to the mobile device 102. Alternatively, in some embodiments a user associated with the mobile device 102 may log on to a web page corresponding to the restaurant food server 120. And the user may responsively download and/or the food compliancy module may synchronize (e.g., as a background task) some or each of the data located within the calorie and nutrition data store 118 to the food compliancy module 110. The data located in the calorie and nutrition data store 118 may provide some or all of the “food information” as described herein such that it can be determined whether the food information complies with a set of food intake criteria tailored to a user, as described in more detail below.

In some embodiments, the computing environment 100 includes a personalized nutrition server 106 that stores food intake criteria for one or more particular users to the food intake criteria data store 114. In some embodiments, a user may upload food intake criteria to (or from) the food intake criteria data store 114 (e.g., via logging on to a particular website and downloading the data). For example, a health specialist (e.g., a nutritionist, doctor, etc.) may have access to the personalized nutrition server 106 such that the health specialist may input initial or additional food intake criteria for a specific patient. For example, if a heart specialist visited with patient X and told patient X that he had some heart issues and should only consume 200 milligrams or less of cholesterol per day, the heart specialist may upload “200 milligrams or less of cholesterol per day” to the patient's food intake criteria within the food intake criteria data store 114. In another example, a user associated with the mobile device 102 may enter particular food intake criteria within the food compliancy module 110 and synchronize or upload the food intake criteria to the food intake criteria data store 114. In another example, the user may synchronize or upload food intake criteria (e.g., generated by a health specialist) from the food intake criteria data store 114 to the food compliancy module 110.

In some embodiments, however, the computing environment 100 may not include the personalized nutrition server 106 as a separate computing system. Rather, the personalized nutrition server 106 and the food intake criteria data store 114 may represent part of an application located within the mobile device 102. Accordingly, the application may include a module configured to receive user input regarding his/her food intake criteria. For example, the user may manually enter his or her calorie intake targets, dietary restrictions, etc. The application may further include the food compliancy module 110.

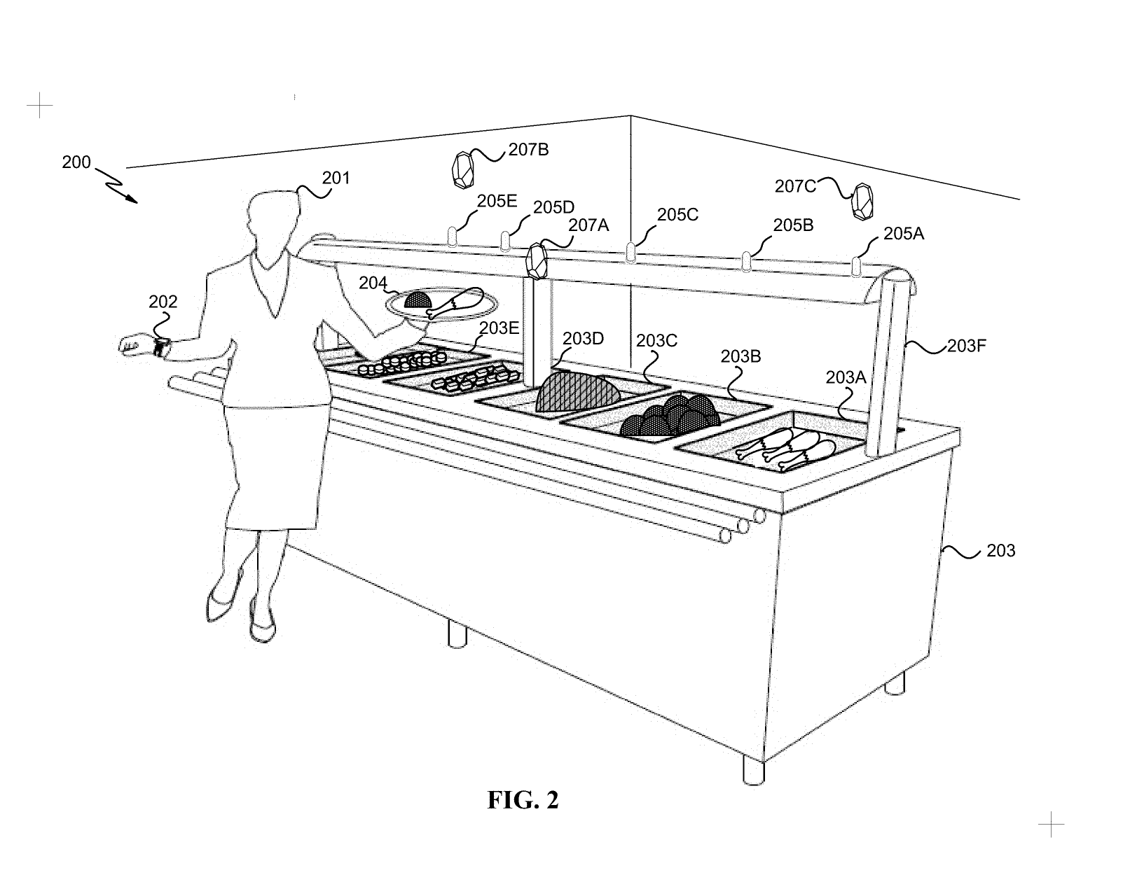

FIG. 2 is a diagram of a buffet environment 200 illustrating how food information may be obtained, according to embodiments. The buffet environment 200 as illustrated in FIG. 2 includes a buffet table 203, individual buffet trays 203A, 203B, 203C, 203D, and 203E within the buffet table 203, a customer 201 that is wearing a mobile device 202 (e.g., a smart watch) and holding a plate 204 (e.g., the sensor device 104 of FIG. 1). The buffet table 203 also includes an extension assembly 203F that is disposed above the buffet trays 203 and extends along the length of the buffet table 203 (and is transversely situated across or perpendicular to the length of each of the buffet trays 203). The extension assembly 203F includes 5 Light Emitting Diodes (LEDs) or sets of LEDs—205A, 205B, 205C, 205D, and 205E. The buffet environment 200 also includes three beacons (e.g., iBEACONS)—beacon 207A attached to the extension assembly 203F, beacon 207B attached to a first wall, and beacon 207C attached to a second wall.

A beacon may be a location transmitter that is used to at least determine a device's physical location/position. A beacon may specifically be a BLE device that broadcasts its identifier (e.g., a Universally Unique Identifier (UUI), Major values, and Minor Values) to those devices that are within a signal strength threshold to listen to the broadcasts. In some embodiments, there may be other positioning systems within the buffet environment 100 instead of or in addition to the beacons (e.g., Global Positioning Systems (GPS), indoor positioning systems that use Wi-Fi (IEEE 802.11) access points, etc.). It is to be understood that in some embodiments, more or less components as illustrated in FIG. 2 may be present (e.g., more beacons, more buffet tables that the buffet table 203, more sensor devices, less buffet trays, etc.). In some embodiments, the beacons 207 may be placed at different locations other than the manner illustrated. It is also to be understood that the mobile device 202 may not necessarily be wearable as illustrated in FIG. 2, and may be any suitable mobile computing device (e.g., a tablet, mobile phone, laptop, or any handheld device).

In an example illustrating how food information may be obtained according to FIG. 2, the customer 201 may first enter the buffet environment 200 (e.g., walk through a restaurant door). In some embodiments, the mobile device 202 (e.g., via the operating system) may begin the process of actively listening for beacon(s) 207 broadcasts. Once the mobile device 202 is within a signal strength threshold of one or more of the beacons 207, the mobile device 202 may receive one or more packets of data that identifies one or more of the beacon(s) 207 within the signal strength threshold. The mobile device 202 may then transmit the identifiers (e.g., as an automated background task) to an associated server computing device (e.g., the restaurant food server 120 of FIG. 1). The associated server computing device may then transmit data (e.g., via a push notification, Short Message Service (SMS) text, an email message, and/or a message to check social media account, etc.) back to the mobile device 202 that is relevant to the positioning of the mobile device based on the beacon identifier(s) the mobile device transmits. For example, the restaurant food server 120 can send a push notification to the mobile device 202 that says “welcome to restaurant X.” The notification may also provide food information (e.g., menus, foods available for selection, calories, fat content, salt content, etc.) for some or all items of food within the buffet environment 200 (e.g., all of the information within the calorie and nutrition data store 118). In an example illustration, a notification may provide nutritional, and/or menu data for each of the food items placed on the buffet table 203 when the mobile device 202 picks up the beacon broadcasts from beacon 207A. Likewise, a notification may provide nutritional and/or menu data for each food item placed in a second buffet table (not shown) when the mobile device picks up beacon broadcasts from beacon 207B, etc.

In some embodiments, the mobile device 202 is configured to receive beacon 207 broadcast(s) as soon as the client 201 walks into the door (or shortly thereafter) such that the mobile device 202 can recommend (e.g., via the food compliancy module 110), prior to the client placing food on the plate 204 (and prior to generating a compliance estimate, as described in more detail below), one or more particular food items that the user should select. The recommending may be based on comparing the food information with the set of food intake criteria. For example, as soon as a push notification or other notification that includes food information is sent to the mobile device 202 (e.g., via one or more beacons 207), the food information can be compared to a set of food intake criteria tailored to the customer 201. The food compliancy module 110, for example, may determine that the user is in the mood for pizza (e.g., via texts sent from the mobile device 202, and/or social media posts, etc.) or that the food intake criteria includes a need to eat a particular quantity of fish per week, and that the customer 201 has not come close to consuming the particular quantity. Accordingly, the food compliancy module 110 may recommend pizza or fish by providing a notification according to the illustrations above. This notification may help the customer 201 select the correct food or food compositions according to his/her food intake criteria and/or the food information within the buffet environment 200.

In some embodiments, the plate 204 may include sensors, such as load sensors and/or object recognition cameras to identify what food item(s) the customer 201 put on the plate 204 and what the portion size of the food item(s) is. For example, the customer 201 may place chicken from the buffet tray 203A and a dinner roll from the buffet tray 203B and place it on the plate 204. The object recognition cameras may then take a snapshot of the chicken and dinner roll and the load sensors may weigh the serving. The plate 204 may then transmit the snapshot of the chicken and dinner roll and the weight identifier to the associated server (e.g., the restaurant food server 120). The associated server may then match the snapshot profile or fingerprint to food items stored in a data store in order to determine that the food is “chicken.” The associated server may then take the weight identifier and calculate a serving size based on the weight. The associated server may then transmit these data (the identity of the chicken and roll and/or the serving size) back to the plate 204 and/or the mobile device 102. The mobile device 202 may then compare (e.g., via the food compliancy module 110) or cross reference this other food information with the food information obtained from the one or more beacons 207 to determine what food item(s) the customer 201 actually put on his plate 204 and other dietary information for the particular serving size. This information may then be compared to the food intake criteria, as described in more detail below.

In another example illustration, after receiving food information via one or more of the beacons 207, the customer 201 may have placed a particular quantity servings of macaroni salad on the plate 204. The plate 204 may then transmit these data to the restaurant food server 120 and the restaurant food server 120 may identify that the food is macaroni salad (e.g., via the picture taken by the plate 204 camera) and that there are 4 servings on the plate 204 (e.g., via the load sensor identifiers sent by the plate 204). The restaurant food server 120 may then transmit these data to the plate 204 (and/or mobile device 102). The plate 204 may have been previously paired (e.g., via a “discovery” Bluetooth® mode) to the mobile device 202 such that the plate 204 and the mobile device 202 can communicate with each other. The plate 204 may then transmit data to the mobile device 202 indicating that there are 4 servings of macaroni salad on the plate 204. The mobile device 202 may then cross reference this data to the food information received via the beacon(s) 207 to determine that 4 servings of macaroni salad contains 1,200 calories (as well as other dietary information about the 4 servings—e.g., salt content, fat content, etc.). The mobile device 202 may then generate, by comparing the food information against a set of food intake criteria tailored to the customer 201, a compliance estimate to determine whether the food information (e.g., 1,200 calories of macaroni salad) complies with the set of food intake criteria. In some embodiments, the mobile device 202 may then provide a notification to the client 200's mobile device 202 based on whether the food information complies with the set of food intake criteria. In some embodiments, the restaurant food server 120 may send the food information obtained from the plate 204 to the mobile device 202 instead of or in addition to the plate 204.

In some embodiments, one or more of the LEDs 205 can help the customer 201 initially select and/or alter one or more food items after he/she has placed food on the plate 204. In some embodiments, each LED may correspond to a particular buffet tray. For example, LED 205A may be associated with buffet tray 203A, LED 205B may be associated with buffet tray 203B, LED 205C may be associated with buffet tray 203C, LED 205D may be associated with buffet tray 203D, and LED 205E may be associated with buffet tray 203E. In an example illustration, referring back to FIG. 1, when the customer 201 walks into a buffet environment, a beacon may broadcast an identifier signal that is picked up by the mobile device 102. The mobile device 102 may then transmit the identifier to the restaurant food server 120. The restaurant food server 120 may then push a notification to the mobile device 102 identifying food information about each item of food. The food compliancy module 110 may then compare the food information with the set of food intake criteria in order to make recommendations. For example, the food intake criteria may specify that the user should not exceed 1,000 calories for this particular meal, and at the same time, the user may like steak, fish, and pizza. The food compliancy module 110 may then determine that pizza is not located in the buffet environment and that the steak includes too many calories. Accordingly, the food compliancy module 110 may recommend that the user eat fish. Therefore, the mobile device 102 may transmit a message back to the restaurant food server 120 indicating that the user should be directed to where the fish is located. The restaurant food server 120 may include a database of each serving platter dish and its associated address for wireless communication. The restaurant food server 120 may then responsively transmit a signal to the buffet tray 203D (or extension assembly 203F), which may cause the LED 205D to blink (or emit a particular color). This may allow the customer 201 to be able to visually identify the LED 205D and associate it with where the fish is located (in buffet tray 203D).

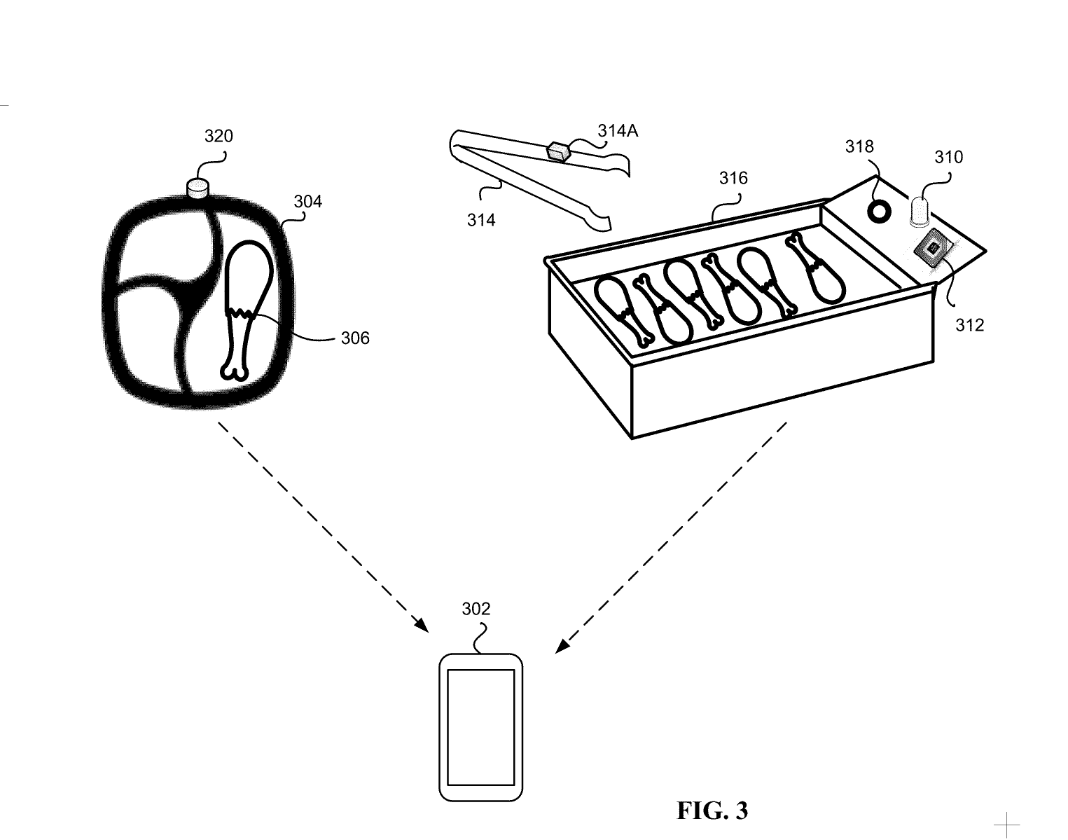

FIG. 3 is a diagram illustrating how food information may be obtained, according to embodiments. FIG. 3 illustrates a SMARTPLATE 304 that includes a sensor 320 and one serving of poultry 306. FIG. 3 also includes the mobile device 302 (which may also be the mobile device 102 and/or the mobile device 202) and the serving platter 316 (e.g., a buffet tray). In various embodiments, the serving platter 316 includes serving utensil 314 (e.g., tongs) that are equipped with a motion sensor 314A (e.g., an accelerometer and/or gyroscope). The serving platter 316 further includes a tag 312, one or more Light Emitting Diodes (LEDs) 310, and one or more other sensors 318. In some embodiments, sensor devices other than the SMARTPLATE may be utilized to represent the functions illustrated by FIG. 3 (e.g., cups, bowls, utensils, etc.).

In some embodiments, the mobile device 302 obtains food information via one or more particular sensors located on the serving platter 316. For example, instead of or in addition to the one or more beacons 207 utilized in FIG. 2, each buffet tray (e.g., buffet tray 203A of FIG. 2) may include a tag 312. The tag 312 may be a RFID tag, an NFC tag, and/or a BLE tag that is interrogated by a corresponding reader within the mobile device 302. In an illustrative example, the mobile device 302 may include a particular radio that includes an RFID reader. The RFID reader may first transmit a radio signal to interrogate a passive (or active) RFID tag (e.g., tag 312) located on the food platter 316. In embodiments, the passive RFID tag may rely on a magnetic field created by the reader. The magnetic field may induce a current to the RFID tag circuit such that the RFID tag provides a unit of data to the mobile device 302. This unit of data may identify the food information associated with the food items (the poultry) within the serving platter 316. For example, the food information may include nutritional or dietary content associated with the poultry only, as opposed to obtaining food information regarding every single food item. In some embodiments, the unit of data (the food information) included on the tag 312 (or unit of data located within a memory/storage device within the food platter 316) may be provided or updated via a remote connection with an associated server (e.g., the restaurant food server 120 may provide data to the tag 312 or memory/storage device via the network 108).

In some embodiments, instead of or in addition to the tag 312 a Universal Product Code (UPC), Quick Response Code (QRC), or other barcode may be available on the serving platter 316 such that by scanning the barcode via a reader/scanner within the mobile device 302, the mobile device 302 may obtain food information associated with the serving platter 316. For example, the mobile device 302 may convert a QRC code to a Uniform Resource Locator (URL) for a website that corresponds with the restaurant food server 120 such that a user will be able to access the website in response to the scanning of the QRC code, as opposed to manually entering the website URL. In other embodiments, a barcode scanner/reader may be located on the serving platter instead of the mobile device 302. And a user may be able to obtain a barcode on the mobile device 302 (e.g., as part of a push notification from the restaurant food server 120 after utilizing beacon technology as described above) such that when the user places the barcode next to the reader/scanner, food information may be obtained by the mobile device 302.

In some embodiments, instead of or in addition to the tag 312 or barcode technology, the motion sensor 314A located on the serving utensil 314 may be utilized to obtain food information about the food items on the serving platter 316. For example the motion sensor 314A may include an accelerometer and gyroscope that detects acceleration changes and angular velocity movements. The motion sensor 314A may be configured to detect when the serving utensil 314 experiences movement above a movement threshold. For example, the serving utensil 314 may be over a movement threshold when a person picks up the serving utensil 314 and starts moving it to place food on the SMARTPLATE 320.

The serving utensil 314 moving above the movement threshold may allow for an inference to be made that a particular person is placing a particular item of food on his/her plate because the corresponding serving utensil 314 is moving. Accordingly, after the serving utensil 314 moves above the movement threshold, the serving utensil 314 may be activated (“woken up”) and may be configured to notify the serving platter 316. The serving platter 316 may responsively query or interrogate its immediate environment to pair with any devices. If the serving platter 316 determines that there is more than one device within a pairing range, the serving platter 316 may be configured to determine the signal strengths of each pairing and send food information to the device associated with the strongest signal strength, which is presumably the device of the person who picked up the serving utensil 314 (i.e., the person closest to the serving platter 316). In some embodiments, the serving utensil 314 may be configured to pair with any device instead of or in addition to the serving platter 316 performing the pairing.

In some embodiments, the serving platter 316 may instead or in addition include the sensor 318. In some embodiments, the sensor 318 represents a microphone such that a person can speak into the microphone to indicate various information such as: the serving portion the user will eat (e.g., one piece of chicken), an identifier of the mobile device 102 (so the system knows where to send food information), and/or the identity of the food. Therefore, in some embodiments, the serving platter 316 may include a natural language processing (NLP) module configured to receive and interpret natural human language. In some embodiments, the information obtained by the microphone may instead or in addition be able to be manually entered (e.g., via a touch screen located on the serving platter 316) by a user.

In some embodiments, the sensor 318 includes or represents one or more tactile sensors (e.g., whiskers, bump sensors, load sensors, pressure sensors (e.g., within touch sensitive skin)). The tactile sensors may be configured to detect when the serving platter 316 is being touched or moved, which may trigger an inference that someone is taking food from the serving platter 316. As described above, the movement or touching experienced by the serving platter 316 may activate the serving platter 316 such that the serving platter 316 queries or pairs with nearby devices (or the nearest device) in order to determine which device to transmit food information to.

In some embodiments, the sensor 318 includes or represents range finder sensors such as sonar, or optical range finders. An optical range finder emits active signals (light) and measures the time until a reflection of this signal arrives back at the optical range finder. In an example illustration, the optical range finder may be configured to activate the serving platter 316 only when the reflection time is below a threshold indicating that a person is substantially close to the serving platter 316. As described above, the reflection time threshold being below a threshold may activate the serving platter 316 such that the serving platter 316 queries or pairs with nearby devices (or the nearest device) in order to determine which device to transmit food information to.

In some embodiments, the serving platter 316 (or somewhere else on a buffet table) includes one or more LEDs 310 in addition to or instead of the LEDs 205 as situated in FIG. 2. The LED 310 may be configured to help recommend a different selection of food item(s) or suggest an initial recommendation of food item(s) before a customer places food on his/her plate. For example, when a customer walks into a buffet environment, a beacon may broadcast an identifier signal that is picked up by the mobile device 302. The mobile device may then transmit the identifier to the restaurant food server 120. The restaurant food server 120 may then push a notification to the mobile device 302 identifying food information about each item of food. The food compliancy module 110 may then compare the food information with the set of food intake criteria in order to make recommendations. For example, the food intake criteria may specify that the user should not exceed 1,000 calories for this particular meal, and at the same time, the user may like steak, fish, and pizza. The food compliancy module 110 may then determine that pizza is not located in the buffet environment and that the steak includes too many calories. Accordingly, the food compliancy module 110 may recommend that the user eat fish. Therefore, the mobile device 302 may transmit a message back to the restaurant food server 120 indicating that the user should be directed to where the fish is located. The restaurant food server 120 may include a database of each serving platter dish and its associated address for wireless communication. The restaurant food server 120 may then transmit a signal to the serving platter 316, which may cause the LED 310 to blink. This may allow the user to be able to find where the recommended food item is.

In some embodiments, the SMARTPLATE 320 is further configured to provide food information to the mobile device 302. In some embodiments, the SMARTPLATE or other dish technology may be improved. For example, in some embodiments, the SMARTPLATE may not include a load sensor because, for example, the serving platter 316 may include a microphone or touch screen to indicate portion size that the user has placed on his/her plate. In another example, the serving platter 316 may instead include a weight platform and load sensor such that a user can place his/her plate on the platform to weigh the plate, which may allow for inferring portion sizes. In some embodiments, the SMARTPLATE may include the sensor 320, which may be a temperature sensor (indicating how hot food is for consumption), a motion sensor to activate the SMARTPLATE, or any other sensor described above.

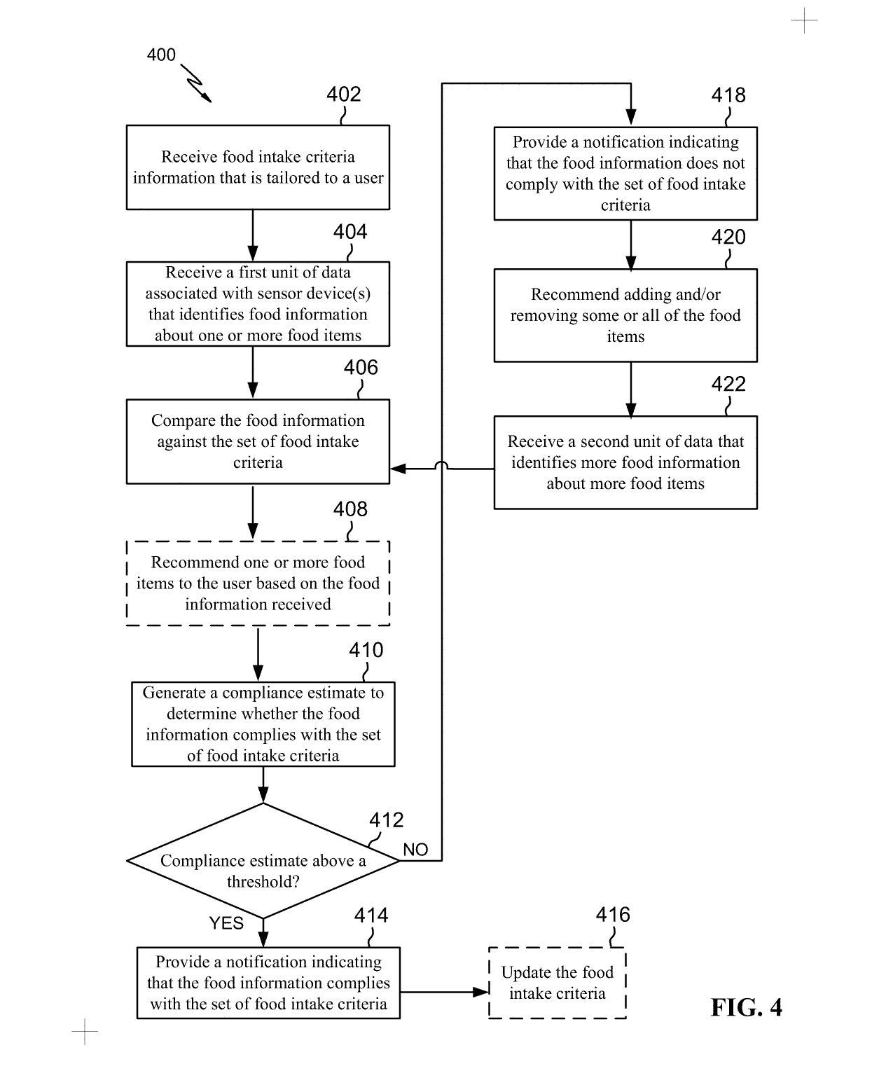

FIG. 4 is a flow diagram of a process 400 for determining whether received food information complies with a set of food intake criteria and recommending to add and/or remove food items responsively, according to embodiments. In some embodiments, each block after block 402 (i.e., blocks 404-422) may be automated or occur as a background task such that a user is not requesting or imputing data on his/her own accord. In some embodiments, the process 400 may begin at block 402 when food intake criteria information is received that is tailored to a user. For example, a user may input (e.g., type or synchronize healthcare professional plans) a set of dietary restrictions (e.g., based on food allergies, special diet regimes, etc.) or food preferences on a mobile device that is associated with a mobile application, such as the food compliancy module 110. The food compliancy module 110/mobile device may thus receive the food intake criteria information.

Per block 404, a first unit (e.g., set) of data associated with one or more sensor devices (e.g., a plate, a beacon, a serving platter, a restaurant food server 120, etc.) may be received that identifies food information about one or more food items. The term “associated” may indicate that a sensor device does not necessarily directly transmit the first unit of data to a computing device (mobile device), but in some embodiments, sensor data may first be transmitted to a server computing device (e.g., the restaurant food server 120) and the server computing device may be the entity that actually transmits the first unit of data. A “food item” may be any particular article or unit of food or drink that is included in a meal (e.g., an apple, a piece of chicken, a hamburger, etc.). The sensor device may make some measurement (e.g., food weight, food identity, nutritional information) of one or more food items that is within an environment (e.g., a restaurant) that the user is in.

In some embodiments, the first unit of data may include sub-units of data from various sources. For example, as described above, the user's mobile device may receive a first sub-unit of data from one or more beacons within a restaurant. The first sub-unit of data may include an identifier of the beacon. The mobile device may then transmit the identifier to a server computing device (e.g., the restaurant food server 120) and the server computing device may responsively transmit nutritional data (e.g., calorie count, salt content, fat content, etc.) of each food item within the restaurant to the mobile device. In another example, as described above, a first sub-unit of data from may be received from one or more sensors (e.g., the tag 312, sensor 318, motion sensor 314) located on a buffet tray of a buffet located within a restaurant. The sensor may transmit nutritional data of one or more food items that are within the buffet tray.

In yet another example, a second sub-unit of data may be received from a transmitter located on a plate that the user will eat on. The plate may include a portion of the one or more food items within a restaurant (e.g., because a customer began the process of placing food on his/her plate). The second sub-unit of data may include information about the portion such as a weight of the portion (e.g., via a load sensor) and an identity of the portion (e.g., via an object recognition camera). In some embodiments, other sub-units of data (e.g., data obtained via the beacons, sensors located on a buffet tray, etc.) may then be cross referenced with the second sub-unit of data in order to obtain a complete set of food information. “Cross reference” may mean to compare, analyze, perform one or more calculations, etc. For example, a first sub-unit of data may give all of the nutritional information concerning each food item within an environment. However, the second sub-unit of data may specifically provide what of those food items a user is going to eat and how much (a serving size) he/she is going to eat. Accordingly, nutritional information may be obtained for a particular serving size of a particular food item that the user has placed on his/her plate. In an example illustration, the calorie and nutrition data store 118 may include nutritional information for one serving size of each food item. When it is found that the user placed 3 serving sizes of a particular item on his/her plate, the restaurant food server 120 (or food compliancy module 110) may then “cross reference” this information by locating a database record within the calorie and nutrition data store 118 that corresponds to the particular food item, identifying the nutritional data per serving of the particular food item, and multiplying the nutritional data by ×3 because the user has placed 3 serving sizes on his/her plate.

Per block 406, the food information may then be compared (e.g., by the food compliancy module 110 or the restaurant food server 120 or the personalized nutrition server 106) against the set of food intake criteria. This comparison may indicate differences, similarities, patterns, and/or calculations between the food intake criteria and the food information received about actual food items. For example, per block 408 and in some embodiments, one or more food items may be recommended to the user based on the food information received. In these embodiments, the food information may include nutritional information about each food item within an environment (e.g., a restaurant). And prior to generating a compliance estimate (block 410), a component (e.g., the food compliancy module 110) may recommend one or more particular food items that the user should select based on comparing the nutritional information with the set of food intake criteria. Accordingly, this recommendation may occur before a user has placed any food item in his/her dish and may be a recommendation to a user of what the user should eat according to his/her food intake criteria. In an example illustration, the food intake criteria may indicate that the user prefers to eat particular foods and avoid particular foods and cannot eat more than X amount of calories for the upcoming meal. Accordingly, the food compliancy module 110 may then compare the food information against the set of food intake criteria by blacklisting the foods to avoid that are a part of a restaurant's menu and then select those food items that the user prefers within the restaurant and select a particular quantity of those food items (a particular serving size) that does not surpass the X amount of calories. The selected food items of the particular quantity may be used to provide the recommendation.

The recommendation as part of block 408 may occur in various manners according to embodiments. For example, the recommendation may include transmitting a signal to a buffet table that corresponds to a particular buffet tray of the buffet table. The signal may cause one or more LEDs located on the buffet table to blink (or power on) such that the user knows where one or more recommended food items are located. For example, the user may be unfamiliar with a buffet restaurant and his mobile device may provide a notification that indicates that a meal has been recommended to the user and that the user should look around the buffet for a blinking light to know where the recommended food items are located.

In some embodiments, the recommendation as part of block 408 may include displaying a map on a user's computing device and an indicator (e.g., a pointer, a reference point, etc.) that identifies where the user needs to go to retrieve the recommended food items. For example, the map may include a buffet table (or restaurant layout) representation and/or a plurality of buffet tray representations within the buffet table representation. A first buffet tray representation may be highlighted or in a different color compared to the rest of the buffet tray representations (i.e., the first buffet tray representation is the indicator). The first buffet tray representation may correspond to the actual (i.e., the tangible) buffet tray the user needs to go to in order to obtain the recommended food item(s). In some embodiments, the recommendation as part of block 408 may include providing a static list to a user's mobile device that describes or identifies the food item(s) that the user should eat.

Per block 410, a compliance estimate may be generated (e.g., by the food compliancy module 110 or other components of FIG. 1) to determine whether the food information complies with the set of food intake criteria. To “comply” or “compliance” as disclosed herein may correspond to food information not violating one or more requirements according to one or more elements of a user's food intake criteria. In these embodiments, food information about what a user has placed on his/her eating dish may have been gathered (e.g., the serving size and identity of a food item a user placed on his/her plate). The compliance estimate may be generated in any suitable manner and may involve static or dynamic calculations. For example, a static calculation may involve comparing various elements of food intake criteria and determining whether the food information violates any of the elements, and if there is any violation, the compliance estimate may be deemed to be above a threshold.

In an example illustration, the food intake criteria may include the user's preferred food items, food items a user cannot eat, a quantity of fat content the user cannot surpass for a given meal, and a food ingredient that the user is allergic to. If the user places a meal on his/her eating dish and it is determined that the user complied with each food intake criteria element, except that the selected serving size caused the fat content to surpass what the criteria specified, then the compliance estimate may not be above a threshold (i.e., there is no compliance). In an example of a dynamic calculation, each element of the food intake criteria may be scored, ranked, and/or weighted such that some elements may take priority over others when performing a compliance estimate. For example, using the illustration above, a compliance estimate over the score of 10 may be considered to be over a threshold and therefore indicate that the food information complies with the set of food intake criteria. If the user selected the user's preferred food items, a score of 5 may be given. If the user avoided eating food items that the user cannot eat, a score of 1 may be given. Because the user surpassed the quantity of fat content, then a score of −2 may be given. If the user avoided eating an ingredient the user was allergic to, the score of 6 may also be given. Therefore, a compliance estimate may calculate a final score of 10 (5+1−2+6) indicating that the food information complies with the set of food intake criteria, notwithstanding that the user has surpassed fat content intake. These dynamic calculations may be the result of factors or elements the user (or other healthcare specialist) deems more crucial (or not as crucial) than others. These dynamic calculations may also greatly differ according to each meal and each person's food intake criteria and therefore may not involve repetitive or simple calculations.

Per block 412, it may be determined whether the compliance estimate is above a threshold (e.g., a score value). Per block 414, if the compliance is above a threshold, then a notification may be provided indicating that the food information complies with the set of food intake criteria. For example, the food compliancy module 110 may cause a user mobile device to display indicia that indicates that what the user has selected is ok for consumption. Per block 416, and in some embodiments, the food intake criteria may be updated. For example, if a user's food intake criteria specifies that he/she should only consume less than 2,000 calories in a given day, then the quantity of calories that the user will eat for a current meal may be added to the calorie count target for the given day. The updating in block 416 may be to prepare for future meals and thus future calculations for determining whether food items will meet the updated set of food intake criteria.

Per block 418, if the compliance estimate is not above a threshold, then a notification may be provided indicating that the food information does not comply with the set of food intake criteria. For example, the food compliancy module 110 may cause a user's mobile device to display a description of why the food information does not comply with the set of food intake criteria (e.g., specifying that there is not compliance because a target calorie count has been exceeded).

Per block 420, a recommendation may be made to add and/or remove some or all of the food items in response to determining that the food information does not comply with the set of food intake criteria. For example, a computing device may recommend a change in portion of the one or more food items (e.g., reducing the quantity of a food item that a person has placed in his plate to reduce a serving size). The computing device may also recommend a different selection of one or more food items. For example, the computing device may recommend substituting 2 cuts of steak with 3 pieces of chicken. Accordingly, and as described above, the recommendation at block 420 may thus cause an original meal selection to be transformed from a first meal selection to a second meal selection.

In some embodiments, the different selection or substitution may be based on how closely a substitute food matches food that has already been selected by a user. For example, referring back to FIG. 1, the calorie and nutrition data store 118 may be a database that includes a column used to identify each food element (e.g., chemical molecules, food ingredients, etc.) that makes up a particular food item. When it is determined that a first food item should be substituted, the calorie and nutrition data store 118 may be scanned in order to find a second food item that includes the most overlapping/shared food ingredients or elements with the first food item. For example, chicken may recommended to be replaced with turkey instead of beef because turkey shares more chemical compounds with chicken than beef does. Or salmon may be recommended to be replaced with trout instead of chicken because trout may share more chemical compounds with salmon than chicken does.

In some embodiments, the recommendation at block 420 may include providing an alert indicating that at least a portion of the one or more food items includes a forbidden food ingredient and recommending a substitute food item that does not include the forbidden food ingredient. For example, as explained above, the calories and nutrition data store 118 may be utilized to find food that does not include the forbidden food ingredient. In some embodiments, the recommendations made at block 420 may be identical or analogous to the methods described at block 406 (e.g., utilizing LEDs and/or displaying a map).

Per block 422, after a user has added and/or removed some or all of the food items to his/her eating dish according to the recommendation at block 420, a second unit of data may be received that identifies more food information about more food items. For example, according to the recommendation at block 420, a user may have removed a brownie and replaced the brownie with a low fat gelatin dessert. The user's food dish may include a load sensor that takes a weight measurement to obtain a portion size and one or more object recognition cameras to take a picture of the gelatin dessert to identify what the user has placed on his/her dish. The information received from the object recognition camera to identify gelatin dessert and the load sensor to obtain a serving size may be the second unit of data at block 422.

After the second unit of data is received at block 422, it may be compared against the set of food intake criteria at block 408. Per block 410, another compliance estimate may be generated to determine whether the current food information—that includes the second unit of data—complies with the set of food intake criteria. Blocks 412, 414, 416, 418, and/or 420 may also be performed with the second unit of data and the process 400 may continue in an analogous manner as illustrated if and until compliance estimate is above a threshold (i.e., the food information complies with the set of food intake criteria).

FIG. 5 is a block diagram of a computing device 500 that includes a food compliancy module 510, according to embodiments. In some embodiments, the computing device 500 represents one or more components of FIG. 1, such as the mobile device 102, the sensor devices 104, the restaurant food server 120, and/or the personalized nutrition server 106. In embodiments, the computing device 500 represents a particular machine or special purpose computer (e.g., a mobile device). The components of the computing device 500 can include one or more processors 06, a memory 12, a terminal interface 18, a storage interface 20, an Input/Output (“I/O”) device interface 22, and a network interface 24, all of which are communicatively coupled, directly or indirectly, for inter-component communication via a memory bus 10, an I/O bus 16, bus interface unit (“IF”) 08, and an I/O bus interface unit 14.

The computing device 500 may include one or more programmable central processing units (CPUs) 06A and 06B, herein generically referred to as the processor 06. In an embodiment, the computing device 500 may contain multiple processors; however, in another embodiment, the computing device 500 may alternatively be a single CPU device. Each processor 06 executes instructions stored in the memory 12.

The computing device 500 may include a bus interface unit 08 to handle communications among the processor 06, the memory 12, the display system 04, and the I/O bus interface unit 14. The I/O bus interface unit 14 may be coupled with the I/O bus 16 for transferring data to and from the various I/O units. The I/O bus interface unit 14 may communicate with multiple I/O interface units 18, 20, 22, and 24, which are also known as I/O processors (IOPs) or I/O adapters (IOAs), through the I/O bus 16. The display system 04 may include a display controller, a display memory, or both. The display controller may provide video, audio, or both types of data to a display device 02. The display memory may be a dedicated memory for buffering video data. The display system 04 may be coupled with a display device 02, such as a standalone display screen, computer monitor, television, a tablet or handheld device display, or another other displayable device. In an embodiment, the display device 02 may include one or more speakers for rendering audio. Alternatively, one or more speakers for rendering audio may be coupled with an I/O interface unit. In alternate embodiments, one or more functions provided by the display system 04 may be on board an integrated circuit that also includes the processor 06. In addition, one or more of the functions provided by the bus interface unit 08 may be on board an integrated circuit that also includes the processor 06.

The I/O interface units support communication with a variety of storage and I/O devices. For example, the terminal interface unit 18 supports the attachment of one or more user I/O devices, which may include user output devices (such as a video display devices, speaker, and/or television set) and user input devices (such as a keyboard, mouse, keypad, touchpad, trackball, buttons, light pen, or other pointing devices). A user may manipulate the user input devices using a user interface, in order to provide input data and commands to the user I/O device 26 and the computing device 500, may receive output data via the user output devices. For example, a user interface may be presented via the user I/O device 26, such as displayed on a display device, played via a speaker, or printed via a printer.

The storage interface 20 supports the attachment of one or more disk drives or direct access storage devices 28 (which may be rotating magnetic disk drive storage devices, although they could alternatively be other storage devices, including arrays of disk drives configured to appear as a single large storage device to a host computer, or solid-state drives, such as a flash memory). In another embodiment, the storage device 28 may be implemented via any type of secondary storage device. The contents of the memory 12, or any portion thereof, may be stored to and retrieved from the storage device 28 as needed. The storage devices 28 may be employed to store any of the data store information described herein, including data stores 118 and 114. The I/O device interface 22 provides an interface to any of various other I/O devices or devices of other types, such as printers or fax machines. The network interface 24 provides one or more communication paths from the computing device 500 to other digital devices and computer systems.

Although the computing device 500 shown in FIG. 5 illustrates a particular bus structure providing a direct communication path among the processors 06, the memory 12, the bus interface 08, the display system 04, and the I/O bus interface unit 14, in alternative embodiments the computing device 500 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 14 and the I/O bus 08 are shown as single respective units, the computing device 500, may include multiple I/O bus interface units 14 and/or multiple I/O buses 16. While multiple I/O interface units are shown, which separate the I/O bus 16 from various communication paths running to the various I/O devices, in other embodiments, some or all of the I/O devices are connected directly to one or more system I/O buses.

In various embodiments, the computing device 500 is a multi-user mainframe computer system, a single-user system, or a server computer or similar device that has little or no direct user interface, but receives requests from other computer systems (clients). In other embodiments, the computing device 500 may be implemented as a desktop computer, portable computer, laptop or notebook computer, tablet computer, pocket computer, telephone, smart phone, smart watch, or any other suitable type of electronic device.

In an embodiment, the memory 12 may include a random-access semiconductor memory, storage device, or storage medium (either volatile or non-volatile) for storing or encoding data and programs. In another embodiment, the memory 12 represents the entire virtual memory of the computing device 500, and may also include the virtual memory of other computer systems coupled to the computing device 500 or connected via a network 30. The memory 12 may be a single monolithic entity, but in other embodiments the memory 12 may include a hierarchy of caches and other memory devices. For example, memory may exist in multiple levels of caches, and these caches may be further divided by function, so that one cache holds instructions while another holds non-instruction data, which is used by the processor. Memory 12 may be further distributed and associated with different CPUs or sets of CPUs, as is known in any various so-called non-uniform memory access (NUMA) computer architectures.

The memory 12 may store all or a portion of the components and data (e.g., the food compliancy module 510) shown in FIG. 5. These programs and data are illustrated in FIG. 5 as being included within the memory 12 in the computing device 500; however, in other embodiments, some or all of them may be on different computer systems and may be accessed remotely, e.g., via a network 30. The computing device 500 may use virtual addressing mechanisms that allow the programs of the computing device 500 to behave as if they only have access to a large, single storage entity instead of access to multiple, smaller storage entities. Thus, while the components and data shown in FIG. 5 are illustrated as being included within the memory 12, these components and data are not necessarily all completely contained in the same storage device at the same time. Although the components and data shown in FIG. 5 are illustrated as being separate entities, in other embodiments some of them, portions of some of them, or all of them may be packaged together.

In an embodiment, the components and data shown in FIG. 5 (e.g., the food compliancy module 510) may include instructions or statements that execute on the processor 06 or instructions or statements that are interpreted by instructions or statements that execute on the processor 06 to carry out the functions as described above. In another embodiment, the components shown in FIG. 5 may be implemented in hardware via semiconductor devices, chips, logical gates, circuits, circuit cards, and/or other physical hardware devices in lieu of, or in addition to, a processor-based system. In an embodiment, the components shown in FIG. 5 may include data in addition to instructions or statements.

In some embodiments, the food compliancy module 510 represents the food compliancy module 110 of FIG.1. The food compliancy module 510 may provide some or all of the processes described in any figure herein, including the process 400 of FIG.4 or other operations relating to FIG. 1, 2, or 3.

FIG. 5 is intended to depict representative components of the computing device 500. Individual components, however, may have greater complexity than represented in FIG. 5. In FIG. 5, components other than or in addition to those shown may be present, and the number, type, and configuration of such components may vary. Several particular examples of additional complexity or additional variations are disclosed herein; these are by way of example only and are not necessarily the only such variations. The various program components illustrated in FIG. 5 may be implemented, in various embodiments, in a number of different ways, including using various computer applications, routines, components, programs, objects, modules, data pages etc., which may be referred to herein as “software,” “computer programs,” or simply “programs.”

The present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for selecting suitable food choices tailored to user preferences, the method comprising:
receiving, by a first computing device, a first unit of data associated with one or more sensor devices, the first unit of data identifying food information about one or more food items;
generating, by comparing the food information against a set of food intake criteria tailored to the user, a compliance estimate to determine whether the food information complies with the set of food intake criteria; and
providing, by the first computing device, a notification to the user based on whether the food information complies with the set of food intake criteria.

2. The method of claim 1, wherein the first unit of data includes a first sub-unit of data, the method further comprising:
receiving, by the first computing device, the first sub-unit of data from a beacon within a restaurant, the first sub-unit of data including an identifier of the beacon, wherein the first computing device transmits the identifier to a server computing device, and wherein the server computing device responsively transmits nutritional data of the one or more food items within the restaurant to the first computing device.

3. The method of claim 2, wherein the first unit of data includes a second sub-unit of data, the method further comprising:
receiving the second sub-unit of data from a transmitter located on a plate that the user will eat on, the plate including a portion of the one or more food items within the restaurant, the second sub-unit of data including information about the portion, the information about the portion including at least one of: a weight of the portion and an identity of the portion; and
cross referencing the first sub-unit of data with the second sub-unit of data in order to obtain the food information.

4. The method of claim 1, further comprising:
determining that the food information does not comply with the set of food intake criteria;
in response to the determining that the food information does not comply with the set of food intake criteria, providing one or more recommendations to the user, the one or more recommendations being selected from a group consisting of: recommending a change in portion of the one or more food items, recommending a different selection of the one or more food items, and providing an alert indicating that at least a portion of the one or more food items includes a forbidden food ingredient and recommending a substitute food item that does not include the forbidden food ingredient.

5. The method of claim 4, wherein the recommending a different selection of the one or more food items includes transmitting a signal to a buffet table that corresponds to a particular buffet tray of the buffet table, and wherein the signal causes one or more Light Emitting Diodes (LEDs) located on the buffet table to blink such that the user knows where the different selection of the one or more food items are located.

6. The method of claim 4, wherein the recommending a different selection of the one or more food items includes displaying a map on the computing device, the map including a buffet table representation and a plurality of buffet tray representations within the buffet table representation, the map further including an indicator identifying a first buffet tray representation that corresponds to a tangible buffet tray that the user needs to go to obtain the different selection of the one or more food items.

7. The method of claim 1, wherein the first unit of data includes nutritional information about each food item within a restaurant, the method further comprising:
recommending, prior to the generating a compliance estimate, one or more particular food items that the user should select based on comparing the nutritional information with the set of food intake criteria.

8. A system for selecting suitable food choices tailored to user preferences, the system comprising:
a first computing device having a processor; and
a computer readable storage medium that includes program instruction, the program instructions executable by the processor to cause the system to perform a method, the method comprising:
receiving a first unit of data associated with one or more sensor devices, the first unit of data identifying food information about one or more food items;
generating, by comparing the food information against a set of food intake criteria tailored to the user, a compliance estimate to determine whether the food information complies with the set of food intake criteria; and
providing a notification to the user based on whether the food information complies with the set of food intake criteria.

9. The system of claim 8, wherein the first unit of data includes a first sub-unit of data, the method further comprising:
Receiving the first sub-unit of data from a beacon within a restaurant, the first sub-unit of data including an identifier of the beacon, wherein the first computing device transmits the identifier to a server computing device, and wherein the server computing device responsively transmits nutritional data of the one or more food items within the restaurant to the first computing device.

10. The system of claim 9, wherein the first unit of data includes a second sub-unit of data, the method further comprising:
receiving the second sub-unit of data from a transmitter located on a plate that the user will eat on, the plate including a portion of the one or more food items within the restaurant, the second sub-unit of data including information about the portion, the information about the portion including at least one of: a weight of the portion and an identity of the portion; and
cross referencing the first sub-unit of data with the second sub-unit of data in order to obtain the food information.

11. The system of claim 8, the method further comprising:
determining that the food information does not comply with the set of food intake criteria;
in response to the determining that the food information does not comply with the set of food intake criteria, providing one or more recommendations to the user, the one or more recommendations being selected from a group consisting of: recommending a change in portion of the one or more food items, recommending a different selection of the one or more food items, and providing an alert indicating that at least a portion of the one or more food items includes a forbidden food ingredient and recommending a substitute food item that does not include the forbidden food ingredient.

12. The system of claim 11, wherein the recommending a different selection of the one or more food items includes transmitting a signal to a buffet table that corresponds to a particular buffet tray of the buffet table, and wherein the signal causes one or more Light Emitting Diodes (LEDs) located on the buffet table to blink such that the user knows where the different selection of the one or more food items are located.

13. The system of claim 11, wherein the recommending a different selection of the one or more food items includes displaying a map on the computing device, the map including a buffet table representation and a plurality of buffet tray representations within the buffet table representation, the map further including an indicator identifying a first buffet tray representation that corresponds to a tangible buffet tray that the user needs to go to obtain the different selection of the one or more food items.

14. The system of claim 8, wherein the first unit of data includes nutritional information about each food item within a restaurant, the method further comprising:
recommending, prior to the generating a compliance estimate, one or more particular food items that the user should select based on comparing the nutritional information with the set of food intake criteria.

15. A computer program product comprising a computer readable storage medium having program code embodied therewith, the program code executable by a first computing device to:
receive a first unit of data associated with one or more sensor devices, the first unit of data identifying food information about one or more food items;
generate, by comparing the food information against a set of food intake criteria tailored to a user, a compliance estimate to determine whether the food information complies with the set of food intake criteria; and
provide a notification to the user based on whether the food information complies with the set of food intake criteria.

16. The computer program product of claim 15, wherein the first unit of data includes a first sub-unit of data, the program code being further executable by the first computing device to:
receive the first sub-unit of data from a beacon within a restaurant, the first sub-unit of data including an identifier of the beacon, wherein the first computing device transmits the identifier to a server computing device, and wherein the server computing device responsively transmits nutritional data of the one or more food items within the restaurant to the first computing device.

17. The computer program product of claim 16, wherein the first unit of data includes a second sub-unit of data, the program code being further executable by the first computing device to:
receive the second sub-unit of data from a transmitter located on a plate that the user will eat on, the plate including a portion of the one or more food items within the restaurant, the second sub-unit of data including information about the portion, the information about the portion including at least one of: a weight of the portion and an identity of the portion; and
cross referencing the first sub-unit of data with the second sub-unit of data in order to obtain the food information.

18. The computer program product of claim 15, wherein the program code is further executable by the first computing device to:
determine that the food information does not comply with the set of food intake criteria;
in response to the determining that the food information does not comply with the set of food intake criteria, provide one or more recommendations to the user, the one or more recommendations being selected from a group consisting of: recommending a change in portion of the one or more food items, recommending a different selection of the one or more food items, and providing an alert indicating that at least a portion of the one or more food items includes a forbidden food ingredient and recommending a substitute food item that does not include the forbidden food ingredient.

19. The computer program product of claim 15, wherein the first unit of data includes a first sub-unit of data, the program code being further executable by the first computing device to:
receive the first sub-unit of data from a sensor located on a buffet tray of a buffet table located within a restaurant, wherein the sensor transmits nutritional data of a food item that is within the buffet tray.

20. The computer program product of claim 15, wherein the set of food intake criteria is based on at least one factor from a group consisting of: a food ingredient intolerance of the user, a food allergy of the user, a special diet regime of the user, a calorie consumption target of the user, and a health-related factor associated with the user.
